(19) United States
(12) Patent Application Publication
(10) Pub. No.: US 2023/0273343 A1
(43) Pub. Date: Aug. 31, 2023

(54) Systems, Methods, and Apparatus for Detection and Early Warning of Tornadoes

(71) Applicant: Jonathan Waldorf, New York, NY (US)

(72) Inventor: Jonathan Waldorf, New York, NY (US)

(21) Appl. No.: 18/166,053

(22) Filed: Feb. 8, 2023

Related U.S. Application Data
(60) Provisional application No. 63/314,596, filed on Feb. 28, 2022.

(51) Int. Cl. G01W 1/10

(52) U.S. Cl. CPC G01W 1/10

(57) ABSTRACT

Methods, apparatus and system for detection and early warning of tornadoes are provided. One method includes operating a portable electronic device by activating a microphone, the microphone contained within the portable electronic device, the microphone capable of receiving a low frequency. Detecting with the microphone a sound wave with a frequency within the low frequency and measuring an intensity of the detected sound wave. Then notifying a user of the portable electronic device of the detection and transmitting a signal to a first remote network device, wherein the transmitted signal contains data related to the detection of the sound wave. This Abstract is provided for the sole purpose of complying with the Abstract requirement rules. This Abstract is submitted with the explicit understanding that it will not be used to interpret or to limit the scope or the meaning of the claims.

### REFERENCE TO RELATED APPLICATION

Priority is claimed to Provisional Application Serial No. 63/314,596, filed Feb. 28, 2022, entitled: “System, Method and Apparatus for Early Disaster Warning,” which is referred to and incorporated herein in its entirety by this reference.

### FIELD OF THE INVENTION

The present invention generally concerns tornado detection and early warning systems, methods, and apparatus. More particularly, the invention concerns a system, methods, and apparatus to detect tornadoes using low frequency sound and to provide warnings of those tornadoes to people at risk.

### BACKGROUND OF THE INVENTION

A tornado is a violently rotating column of air that extends from a thunderstorm and meets the ground, according to the National Oceanic and Atmospheric Administration (NOAA). In an average year about 1,000 tornadoes are reported in the United States. Tornadoes pose a significant risk to life and property to many people. Because of their relatively small size and location close to the ground, tornadoes are difficult to detect and track at long distances using radar (the most widely deployed weather detection technology), leading researchers to look for other ways to detect tornadoes.

According to a recent NOAA white paper, “[t]here is evidence that infrasonic observing systems have significant potential to improve tornado warnings. The near infrasound systems applied in this research provide a new way of hearing low frequency sounds in the atmosphere and focus on a different, higher frequency window than historical infrasonic research dating to the 1970’s.” Additionally, researchers have found that tornado-producing storms can emit infrasound more than an hour before tornado genesis, which inspired a group of researchers to develop a long-range, passive way of listening in on storms.

Research entities such as the National Center for Physical Acoustics (NCPA) have found ways to detect and track tornadoes with low frequency sound known as “infrasound.” This work at NCPA by Waxler et al. shows that tornadoes emit infrasound in a range between 0.5 Hz to 5 Hz. Field sensors have demonstrated the practical ability to detect infrasound signals from tornadoes with enough data to track them. Current field sensors detect and record data, storing it for later manual retrieval, with the data extracted and processed back at the lab. This process while encouraging, is inefficient in creating an effective and efficient real-time detection and early warning system for deadly storms that pose real and significant threats for many people.

From January 1 to Dec. 14, 2021, there were 1,254 tornadoes in the United States, compared with 1,075 in all of 2020, according to data from NOAA. Tornadoes killed over 100 people in 2021. In 2020, 76 people perished in tornadoes. Some estimates of property damage in the US related to tornadoes put 2020 as a record year with insurance company estimates reaching as much as 36 billion US dollars.

As climate change may make tornadoes more frequent and deadly, there is a public need for a tornado detection and warning system deployed straight to people’s phones, saving lives and minimizing damage to mobile property at minimal cost and effort. Therefore, a need exists for a detection and early warning system, methods, and apparatus for tornadoes.

### SUMMARY OF THE INVENTION

Embodiments of the present invention provide systems, methods, and apparatus for detection of emergency conditions in a geographical region and methods and apparatus for early warning users of the emergency conditions and in some embodiments recommending actions to the users. A provided embodiment is directed to a method of operating a portable electronic device. The portable electronic device contains a microphone, communication circuits, a processor, and a display. In one embodiment, the device activates the microphone and listens for sounds in a low frequency range. Once a sound is detected in this range its amplitude or intensity is measured and the user of the device is notified that a sound has been detected in that range. The device then transmits a data signal containing information about the detected sound to a network device. In some embodiments, detection of sound in this frequency range may indicate the presence of a tornado in the local geographical region.

In other embodiments, the portable electronic device is configured to receive an alert message from a network device, the alert message related to the existence of an emergency condition. In some of these embodiments a map is displayed on the portable electronic device indicating the type and/or location of the emergency condition. In further embodiments, the data displayed includes the speed and direction of the emergency condition such as a tornado.

In a further provided embodiment a method of operating network equipment is disclosed. In this embodiment the network equipment is configured with a microphone sensitive in a low frequency range. In some embodiments these microphones are directional allowing for more precise indication of the location of the source of the sound. Once the network equipment detects sound in this low frequency range, its amplitude or intensity is measured. A data message is then sent from the network equipment to at least one portable network equipment in the geographical region.

In some embodiments the data message contains information related to an emergency condition in the geographical area. In one exemplary embodiment the emergency condition is the existence of a tornado in the vicinity and the message contains the time of the detection of the low frequency sound wave, or the intensity of the detected wave, or the location of the network equipment, or the direction of the detection, or the frequency of the wave, or the geographical coordinates of the tornado, or the speed and direction of the tornado.

Further provided embodiments include methods of operating a communication network. These networks typically contain multiple base stations or network access points which may have many different names and functions depending on the type of network. The networks further include multiple portable electronic devices. In some embodiments, the network equipment includes microphones which are sensitive in a low frequency range. If sound is detected in this low frequency range the network equipment, or alternatively another network equipment sends a data signal to the portable electronic devices in the geographical vicinity. The receiving devices display an alert message to the user that an emergency condition has been detected in the region. In some further embodiments the portable electronic equipment displays a recommended action or other information related to the emergency to the user.

These and other features and advantages of the present invention will be appreciated from review of the following detailed description of the invention, along with the accompanying figures in which like reference numerals refer to like parts throughout.

### BRIEF DESCRIPTION OF THE DRAWINGS

Various embodiments of the present invention taught herein are illustrated by way of example, and not by way of limitation, in the figures of the accompanying drawings, in which:

FIG. 1 illustrates a prior art communication network where aspects of the present invention may be deployed;

FIG. 2 illustrates various network equipment deployed in prior art cellular networks where embodiments of the present invention may be deployed;

FIG. 3 illustrates a method of operation of a portable electronic device according to one embodiment of the present invention;

FIG. 4 illustrates an additional method of operation of a portable electronic device according to another embodiment of the present invention;

FIG. 5 illustrates a method of operation of a network equipment according to yet another embodiment of the present invention;

FIG. 6 illustrates a communication flow between network equipment and portable electronic devices according to one embodiment of the present invention;

FIG. 7 is a functional block diagram of a portable electronic device consistent with some provided embodiments of the present invention; and

FIG. 8 is a functional block diagram of network equipment consistent with some provided embodiments of the present invention.

It will be recognized that some or all of the figures are schematic representations for purposes of illustration and do not necessarily depict the actual relative sizes or locations of the elements shown. The Figures are provided for the purpose of illustrating one or more embodiments of the invention with the explicit understanding that they will not be used to limit the scope or the meaning of the claims.

### DETAILED DESCRIPTION OF THE INVENTION

In the following paragraphs, the present invention will be described in detail by way of example with reference to the attached drawings. While this invention is capable of embodiment in many different forms, there is shown in the drawings and will herein be described in detail specific embodiments, with the understanding that the present disclosure is to be considered as an example of the principles of the invention and not intended to limit the invention to the specific embodiments shown and described. That is, throughout this description, the embodiments and examples shown should be considered as exemplars, rather than as limitations on the present invention. Descriptions of well known components, methods and/or processing techniques are omitted so as to not unnecessarily obscure the invention. As used herein, the “present invention” refers to any one of the embodiments of the invention described herein, and any equivalents. Furthermore, reference to various feature(s) of the “present invention” throughout this document does not mean that all claimed embodiments or methods must include the referenced feature(s).

Acoustics is the study of sound waves -- emission, transmission and detection. Sound waves oscillate and frequency is defined as the number of oscillations (one up and down wave) per second, with one oscillation equal to 1 Hertz (Hz). Signal processing is how to interpret signals (such as sound waves) for meaningful information. Human hearing is in the frequency range between 20 Hz to 20 kilo Hz, below that is called infrasound. As discussed above, the work of NCPA (Waxler et al.) shows that tornadoes emit infrasound in a range between 0.5 Hz to 5 Hz. As defined herein, low frequency sound waves range between 0.5 Hz to 20 Hz. NCPA field sensors have demonstrated the practical ability to detect infrasound signals from tornadoes with enough data to track them. Field sensors detect and record data, storing it for later manual retrieval, with the data extracted and processed back at the laboratory. Once back at the laboratory, the field data can be combined with specific sensor location and time data. Then, signal processing of retrieved acoustic data can be used to calculate tornado position, direction, and velocity. However, this information is developed long after the tornado event.

The present invention proposes real-time calculation of tornado position, direction, and velocity employing cellular phones equipped with infrasound detecting hardware and/or software to detect infrasound generated by a tornado. This information can then be distributed via the cellular network to alert individuals threatened by the tornado.

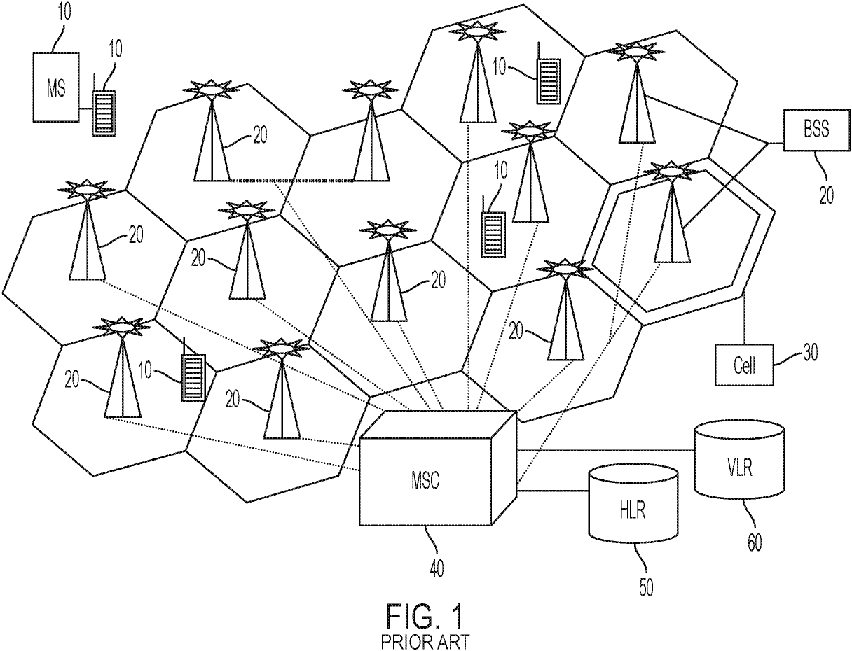

Aspects of the present invention may be best understood within the context of a typical cellular network which is illustrated in prior art FIG. 1. In cellular communication networks a geographical area is divided into cells 30, each containing network equipment 20. (Labeled in FIG. 1 as BSS to denote Base Station Subsystem) A typical BSS will include Base Transceiver Station (BTS) which contains the equipment for transmitting and receiving radio waves. Equipment can include transmitters, receivers, antennas, amplifiers, encryption and decryption equipment and equipment configured to communicate with the Base Station Controller (BTS). As illustrated in FIG. 1 several portable electronic devices 10 (i.e., cell phones, tablets, laptops or other electronic devices) are in communication with network equipment 20. In this depiction the portable electronic device 10 is illustrated as a Mobile Station (MS). FIG. 1 also illustrates the Mobile Switching Center (MSC) 40 and Visitor Location Register (VLR) 60. VLR 60 is a database of containing the portable electronic devices 10 that have entered the geographic location under control of the Mobile Switching Center 40. In 2G cellular, the MSC 40 was the primary service delivery node routing voice and data to the appropriate network equipment 20 (BSS in FIG. 1) serving the portable electronic device 10. (MS 10 in FIG. 1).

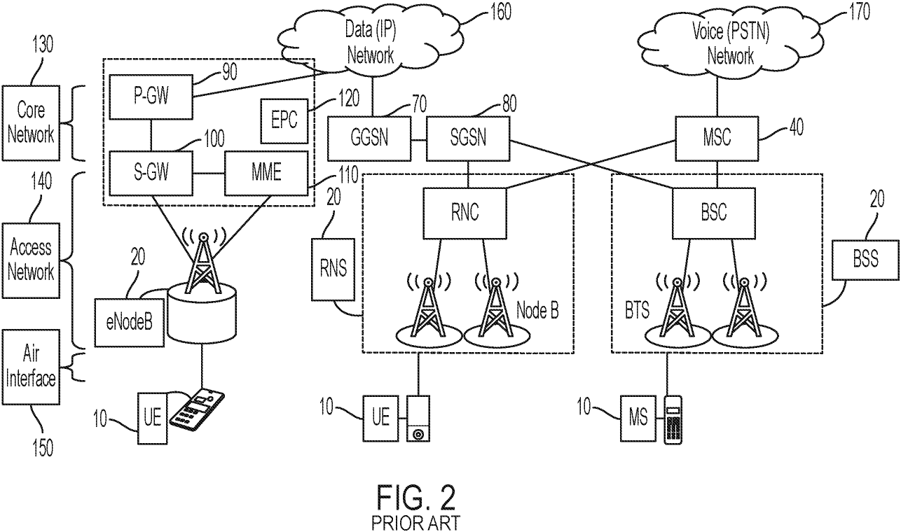

As communication technology advanced through 3^{rd} and 4^{th} Generation Cellular (3G and 4G) various types of portable electronic equipment 10 are supported and network equipment 20 has grown in complexity. As illustrated in FIG. 2, the progression of cellular technology through 2G, 2.5G, 3G, and 4G has added additional functionality to network equipment 20 and allowed it to support a wider range of portable electronic devices 10. On the right of FIG. 2 is illustrated some of the components discussed with respect to FIG. 1. Portable electronic equipment 10 (seen as MS 10) is in communication with network equipment 20 (illustrated as BSS containing BTS and BSC as previously discussed and limited data services being managed by the network equipment 20 (illustrated as MSC 40) in communication with the voice Public Switched Telephone Network (PSTN) 170. With the adoption of advanced data services into the 2G architecture, some additional network equipment 20 was required. This new network equipment 20 was part of what was commonly referred to as 2.5G.

As illustrated in FIG. 2 the Service gateway GPRS support node (SGSN) 80 and a Gateway GPRS node (GGSN) 70 are added to further communication between the portable electronic devices 10 and Data IP Network 160. As technology advanced and was adopted into the network, additional data resources were needed to manage and facilitate the increased power of a new family of portable electronic devices 10 (illustrated in 3G section as User Equipment - UE). In 3G cellular the network equipment responsible for allowing the portable electronic device 10 to access the networks was called the Radio Network Subsystem (RNS). It included air interface 150 network equipment 20 referred to as Node B and Radio Network Controller (RNC). In 3G cellular networks this equipment served many of the functions that the BSS served in 2G and 2.5G cellular. As illustrated 3G network equipment 20 communicates to both data (IP) network 160 through SGSN 80 and GGSN 70 and to Voice (PSTN) Network 170 through MSC 40.

FIG. 2 additionally illustrates 4th Generation (4G) network architecture. In this portion of FIG. 2 portable electronic device 10 (referred to as UE) is in communication with network equipment 20 (eNodeB) across air interface 150. In 4G cellular access network 140 consists of network equipment 20and access points to the Evolved Packet Core (EPC) 120 of Core Network 130. EPC 120 is comprised of Mobile Management Entity (MME) 110 which is the main signaling element of EPC 120 and Serving Gateway S-GW 100 which communicates with data IP Network 160 through PDN Gateway (P-GW) 90. It will be appreciated by those of skill in the art that communication in a 2G network consist of circuit switched communication whereas technology advanced to 4G the communication with the network is all packet switched. Further, many portable electronic devices 10 are backwards compatible with 2G, 3G, 4G, and 5G networks (not illustrated in FIG. 2). Indeed, while embodiments of the present invention are illustrated in connection with the cellular architectures depicted in FIG. 2, the invention is not limited to these portable electronic devices 10, or any particular network equipment 20, as discussed below.

As known in the art, the Commercial Mobile Alert System (CMAS) is a public safety system that allows enabled portable electronic device 10 to receive geographically-targeted, messages alerting them of imminent threats to safety in their area. As known in the art CMAS technology ensures that emergency alerts will not get stuck in highly congested user areas, which can happen with mobile voice and texting services. CMAS was established pursuant to the Warning, Alert and Response Network (WARN) Act. CMAS enables government officials to target emergency alerts to specific geographic areas through network equipment, which pushes the information to dedicated receivers in CMAS-enabled portable electronic devices 10. CMAS complements the existing Emergency Alert System (EAS) which is implemented by the Federal Communication Commission (FCC) and Federal Emergency Management Agency at the federal level through broadcasters and other media service providers.

CMAS works with the Wireless Emergency Alert (WEA) system and provides for the delivery of a short alert message (90 characters or less) to portable electronic devices 10 within a specific geographical area using a broadcast channel from network equipment 20. It offers several unique benefits that position WEA as a critical national utility for supporting public safety. CMAS supports three types of alerts, Presidential Alerts, Amber Alerts and Alerts related to imminent life-threatening situations. While the CMAS system is one example of emergency alerts that portable electronic devices 10 may receive, embodiments of the present invention are not limited to the use of this system.

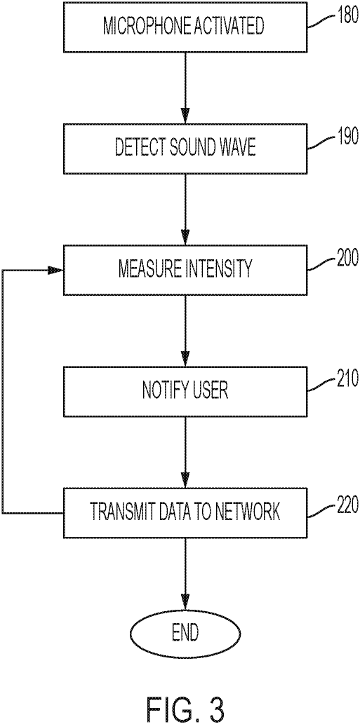

FIG. 3 illustrates a method of use of a portable electronic device 10 consistent with some embodiment of the present invention. In this method flow begins at block 180 where a microphone within portable electronic device 10 is activated. This step of activation may be accomplished automatically when the device is powered on, or the user of the device may activate the microphone through a user interface. Flow continues to 190 where a low frequency sound wave is detected by the microphone. As discussed above, this low frequency can be below the audible frequency range of the human ear and in some instances can be indicative of the presence of a tornado or dangerous storm capable of spawning a tornado. The portable electronic device 10 may employ computer software, such as “InfraSound Detector” software (developed by Sergio Gudkov, and available on Google Play) or “Infrasound Recorder” software (developed by RedVox, and available on the Apple Store for iPad tablets), or other software that has been downloaded into the portable electronic device 10. Alternatively, the electronic portable device 10 may communicate with a microphone, or sound level meter or a decibel meter to detect low frequency sound waves.

Referring again to FIG. 3, the flow continues to 200 where the intensity (or magnitude) of the sound is measured and in 210 the user of portable electronic device 10 is notified of the presence of the low frequency sound. In various embodiments this notification can take the form or a popup alert on the display of portable electronic device 10, an icon on a map drawn on the display of portable electronic device 10, or an audible alert from the speaker of portable electronic device 10. Flow continues to 220 where the portable electronic device 10 sends a signal to network device 20. The signal contains data related to the detection of the low frequency sound. In some embodiments this data may also contain the GPS location of the portable electronic device 10, the intensity or magnitude of the detected wave, an estimated direction of travel of the sound source, and an estimated velocity of travel of the sound source. In some embodiments flow continues back to 200 and completes a second iteration of measurement, notification, and data transmission. In other embodiments the step of notifying user 210 on the second iteration is bypassed.

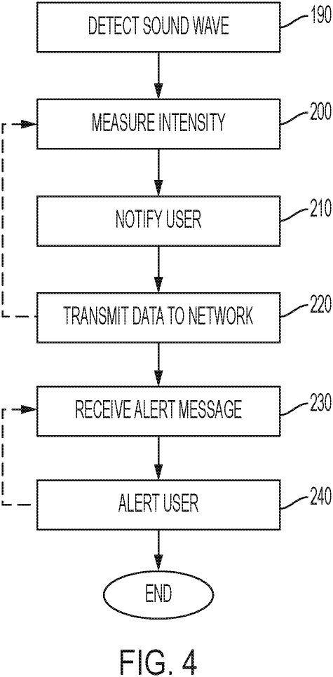

Next, FIG. 4 illustrates another method of use of a portable electronic device 10 consistent with some embodiment of the present invention. In this method flow begins at block 180 where a microphone within portable electronic device 10 is activated. This step of activation may be accomplished automatically when the device is powered on, or the user of the device may activate the microphone through a user interface. Flow continues to 190 where a low frequency sound wave is detected by the microphone. This detection may be performed by the software installed in the portable electronic device 10 or by a microphone or other type of detector, as discussed above in connection with FIG. 3. And, as discussed above, this low frequency can be below the audible frequency range of the human ear and in some instances can be indicative of the presence of a tornado or dangerous storm capable of spawning a tornado.

Referring again to FIG. 4, flow continues to 200 where the intensity (or magnitude) of the sound is measured and in 210 the user of portable electronic device 10 is notified of the presence of the low frequency sound. In various embodiments this notification can take the form or a popup alert on the display of portable electronic device 10, an icon on a map drawn on the display of portable electronic device 10, or an audible alert from the speaker of portable electronic device 10. Flow continues to 220 where the portable electronic device 10 sends a signal to network device 20. The signal contains data related to the detection of the low frequency sound. In some embodiments this data may also contain the GPS location of the portable electronic device 10, the intensity or magnitude of the detected wave, an estimated direction of travel of the sound source, and an estimated velocity of travel of the sound source. In some embodiments flow continues back to 200 and completes a second iteration of measurement, notification, and data transmission. In other embodiments the step of notifying user 210 on the second iteration is bypassed. In some embodiments, flow continues to 230 where an alert message is received by portable electronic device 10 from network device 20. As with other embodiments iteration on the steps measurement, notification and transmission (200, 210, and 220) is optional. As is the second or further receiving alert message 230 and alerting the user 240.

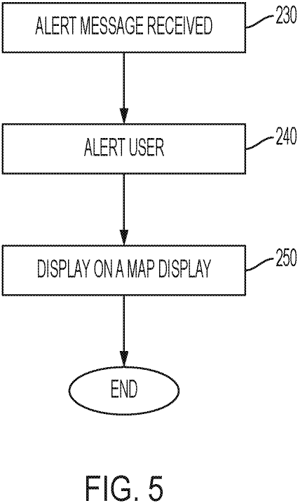

An additional embodiment of operating a portable electronic device 10 is illustrated in FIG. 5. In this embodiment, a portable electronic device 10 may be equipped with a microphone not capable of detecting low frequency sound or in some instances a user may have disabled the microphone. In these embodiments an alert message is received from network equipment 20 in step 230, flow continues to 240 where the user is alerted. Flow continues to 250 where a map containing an indication of the emergency condition is displayed. In some embodiments the flow iterates through steps 230, 240, and 250 updating the display with information on emergency condition. In some embodiment provided herein the alert messages can also contain information on the size, speed, and direction of a tornado. Additionally alert messages may contain recommendations for evasive action the user should take.

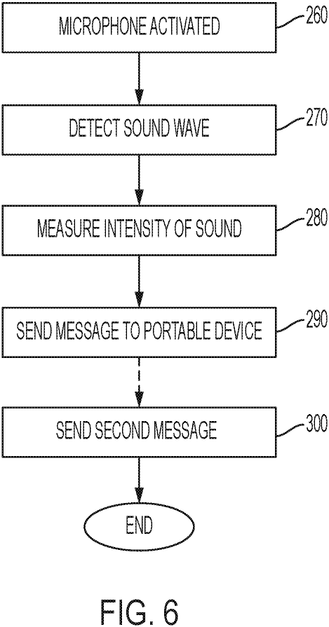

The flow of a provided method of operating a network device 20 is illustrated in FIG. 6. In some embodiments network device 20 includes fixed microphones sensitive to a frequency range below human hearing. As illustrated flow begins in 260 where the microphone is activated. As is known in the art these fixed microphone locations may be directional microphones or omnidirectional microphones. Flow continues to 270 where a low frequency sound wave is detected. As previously discussed, the frequency range can be from 0.5 Hertz to 20 Hertz. Once sound in this range is detected, the intensity or magnitude of the wave is measured in 280. Flow continues to 280 where network equipment 20 sends a message to one or more portable devices 10 in a specific geographical area. In some embodiments flow continues to 300 where an update message is sent to portable devices 10. In these embodiments the messages sent to portable devices 10 may include the size, direction, and location of a tornado. In further embodiments the message may additionally include suggested evasive action for the operator of one or more portable electronic devices 10. In some embodiments, the second message may be sent from a different network device 20 and in others the same network device 20 is the one that sent the first message. In some embodiments the first or the second message may be sent over a broadcast channel.

As shown in FIGS. 3-6, and discussed above, the present invention enables the real-time, or near real-time dissemination of information relating to a tornado size, direction, and location to operators of portable electronic devices 10. This real-time information can be crucial to avoid death or injury to individuals located in the tornado’s path.

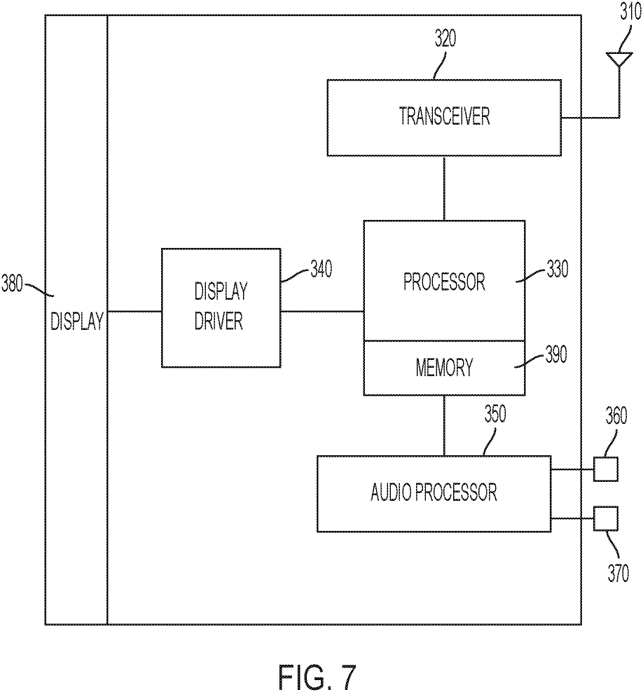

A functional block diagram of provided embodiments of portable electronic device 10 is illustrated in FIG. 7. Portable electronic device 10 contains at least one antenna 310 enabled to communicate with network equipment 20. Antenna 310 is connected to communication transceiver 320 which sends and receives signals from network equipment 20. It further down converts the received frequency signals, and up converts signals to send to the appropriate frequency range. Transceiver 320 is connected to processor 330 which is responsible for processing functions on the portable electronic device 10. As illustrated, processor 330 contains a memory section 390 where processor executable instructions may be stored. These executable instructions are sufficient to configure the portable electronic device 10 to practice the provided methods herein. In some embodiments (not shown) processor 330 may be in communication with additional persistent memory in portable electronic device 10. Processor 330 is further in communication with an audio processing module 350 which is responsible for communication with microphone 360 and speaker 370. Processor 330 is further in communication with a display driver 340 which in some embodiments, is responsible for control of and communication with display 380. As previously discussed, portable electronic device 10 may be a cell phone, a smartphone, a tablet computer, a handheld computer, or a laptop computer.

As will be appreciated by one of skill in the art, embodiments of the present invention may be provided as methods, systems, or computer program products. Accordingly, the present invention may take the form of an entirely hardware embodiment, an entirely software embodiment or an embodiment combining software and hardware aspects, for example, such as portable electronic device 10. Furthermore, the present invention may take the form of a computer program product which is embodied on one or more computer-usable storage media (including, but not limited to, disk storage, CD-ROM, optical storage, integrated circuits and so forth) having computer-usable program code embodied therein. These computer program instructions may also be stored in a computer-readable memory that can direct a computer or other programmable data processing apparatus to function in a particular manner, such that the instructions stored in the computer-readable memory produce an article of manufacture including instruction means which implement the functions discussed above in this specification.

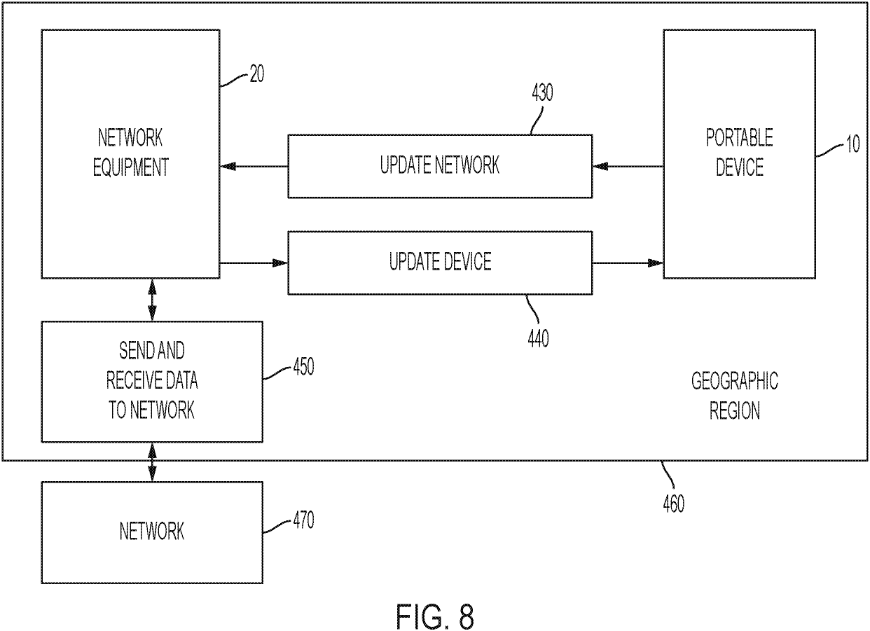

The flow of messages in a provided method of communication in a network is illustrated in FIG. 8. As illustrated in FIG. 1 and further in FIG. 8, there are a plurality of portable electronic devices 10 in communication with network equipment 20 in a given geographical region 460. In some embodiments portable electronic device 10 is configured with a microphone capable of sound detection in a low frequency range. In other provided embodiments, network equipment 20 is configured to contain microphones sensitive in the same low frequency range. Upon a sound detection event 400 portable electronic device 10 sends message 410 to network equipment 20. As previously discussed, this message may contain the time of detection, the intensity or magnitude of sound detected, the location of the portable electronic device 10, an estimate of the location, direction, and speed of the source of the sound. Upon detection of a low frequency sound wave 410 by network equipment 20 and/or the receipt of message 410 from portable electronic device 10, network equipment 20 sends a notification message 420 to some of a plurality of portable electronic devices 10 within geographical region 460. In some embodiments this message 420 contains the size, location, direction, and/or speed of the source of the sound either detected by network equipment 20 or reported to the network in message 410. In some embodiments, network equipment may send and receive a plurality of messages from other network equipment in communication exchange 450. In some embodiments these messages in communication exchange 450 may include mapping information from mapping servers. In some illustrated embodiments portable electronic device 10 may send update messages 430 to network equipment 20. These update messages may contain further information about the location, estimated speed, and estimated direction of the detected sound source, these messages may also include the time and intensity or magnitude of sound detection and the GPS position of the portable electronic device 10. In some further embodiments, the network equipment 20 may send update messages 440 to some of the plurality of portable electronic devices. These messages may include updated position, speed and direction of the source of sound and may also include mapping information and recommended course of action for the user.

It will be appreciated that electronic devices discussed herein that are in communication with each other need not be in continuous communication with each other, unless expressly specified otherwise. In addition, devices that are in communication with each other may communicate directly or indirectly through one or more intermediaries. A description of an embodiment of the present invention with several components in communication with each other does not imply that all such components are required.

As discussed above in connection with FIGS. 3-6, method steps may be described in a sequential order, however, such methods may be configured to work in alternate order. In other words, any sequence or order of steps that may be described does not necessarily indicate a requirement that the steps be performed in that order. The steps of processes described herein may be performed in any practical order. Further, some steps may be performed simultaneously.

A description of an embodiment with several components in communication with each other, such as portable electronic device 10, does not imply that all such components are required. For example, when a single device or article is described herein, it will be readily apparent that more than one device/article (whether or not they cooperate) may be used in place of a single device/article. Similarly, where more than one device or article is described herein (whether or not they cooperate), it will be readily apparent that a single device/article may be used in place of the more than one device or article.

The present invention may be implemented on a computer-readable medium. The term “computer-readable medium” as used herein refers to any medium that participates in providing data (e.g., instructions) which may be read by a computer, a processor or a like device. Such a medium may take many forms, including but not limited to, non-volatile media, volatile media, and transmission media. Non-volatile media include, for example, optical or magnetic disks and other persistent memory. Volatile media include dynamic random access memory (DRAM), which typically constitutes the main memory. Transmission media include coaxial cables, copper wire and fiber optics, including the wires that comprise a system bus coupled to the processor. Transmission media may include or convey acoustic waves, light waves and electromagnetic emissions, such as those generated during radio frequency (RF) and infrared (IR) data communication. Common forms of computer-readable media include, for example, a floppy disk, a flexible disk, hard disk, magnetic tape, any other magnetic medium, a CD-ROM, DVD, any other optical medium, a RAM, a PROM, an EPROM, a FLASH-EEPROM, any other memory chip or cartridge, a carrier wave as described hereinafter, or any other medium from which a computer can read. Moreover, the present invention may also be downloaded as a computer program product, wherein the program may be transferred from a remote computer to a requesting computer by way of data signals embodied in a carrier wave or other propagation medium via a communication link (e.g., a wired/wireless modem or network connection).

It is to be noticed that the term “comprising”, used in the claims, should not be interpreted as being limitative to the means listed thereafter. Thus, the scope of the expression “a device comprising means A and B” should not be limited to devices consisting only of components A and B. It means that with respect to the present invention, the only relevant components of the device are A and B. In addition, the terms “an embodiment”, or “one embodiment” mean “one or more (but not all) embodiments of the present invention(s)” unless expressly specified otherwise. Finally, the terms “a”, “an” and “the” mean “one or more”, unless expressly specified otherwise.

Thus, it is seen that novel systems, methods, and apparatus for detection and early warning of tornadoes is provided. One skilled in the art will appreciate that the present invention can be practiced by other than the above-described embodiments, which are presented in this description for purposes of illustration and not of limitation. The specification and drawings are not intended to limit the exclusionary scope of this patent document. It is noted that various equivalents for the particular embodiments discussed in this description may practice the invention as well. That is, while the present invention has been described in conjunction with specific embodiments, it is evident that many alternatives, modifications, permutations and variations will become apparent to those of ordinary skill in the art in light of the foregoing description. Accordingly, it is intended that the present invention embrace all such alternatives, modifications and variations as fall within the scope of the appended claims. The fact that a product, process or method exhibits differences from one or more of the above-described exemplary embodiments does not mean that the product or process is outside the scope (literal scope and/or other legally-recognized scope) of the following claims.

What is claimed is:

1. A method of operating a portable electronic device comprising:
activating a microphone, the microphone contained within the portable electronic device, the microphone structured to receive a low frequency;
detecting with the microphone a sound wave with a frequency within the low frequency;
measuring an intensity of the detected sound wave;
notifying a user of the portable electronic device of the detection; and
transmitting a signal to a first remote network device, wherein the transmitted signal contains data related to the detection of the sound wave.

2. The method of claim 1, where the low frequency is below 20 Hertz.

3. The method of claim 1, where the notification of the user is a notification of an emergency condition, and wherein the emergency condition is the existence of a tornado in a vicinity of the user.

4. The method of claim 1, where the data related to the detection is selected from the group consisting of: an intensity of the sound, a time of detection, a frequency of the detected sound, and a combination of two or more thereof.

5. The method of claim 1, further comprising:
receiving from a second remote network device an alert message; and
alerting the user of an emergency condition.

6. The method of claim 5, where the emergency condition is the existence of a tornado in a vicinity of the user.

7. The method of claim 5, where the first and the second remote network devices are the same network device.

8. The method of claim 6, where alerting the user comprises displaying a map on a display on the electronic device, the map indicating the location of the tornado.

9. A method of operating a network device comprising:
activating a microphone, the microphone structured to receive a low frequency;
detecting with the microphone a sound wave with a frequency within the low frequency;
measuring an intensity of the detected sound wave;
sending a message to a plurality of portable electronic devices, the plurality of portable electronic devices within a geographic region.

10. The method of claim 9, where the microphone is a directional microphone.

11. The method of claim 9, where the message contains information related to an emergency condition.

12. The method of claim 11, where the emergency condition is an existence of a tornado in the geographical region, where the message includes information selected from the group consisting of: a time of a detection of the sound wave, an intensity of a detected sound wave, a location of a network equipment, a direction of a detected sound wave, a frequency of a sound wave, a geographical coordinate of the tornado, and a combination of two or more thereof.

13. The method of claim 9, further comprising sending from a network equipment a second message to the plurality of portable electronic devices, the second message containing data related to an update of a status of an emergency condition.

14. The method of claim 9, where the low frequency is below 20 Hertz.

15. A method of operating a communication network, the communication network comprising a plurality network equipment and a plurality of portable communication devices, the method comprising:
detecting a low frequency sound wave with a directional microphone at a first network equipment;
transmitting a data signal from a second network equipment to at least one of the plurality of portable communication devices;
receiving the data signal at the at least one portable communication device;
displaying an alert to a user of the at least one portable communication device of an emergency condition in their geographical region; and
displaying a recommended action to the user of the at least one portable communication device.

16. The method of claim 15, where the low frequency sound wave has a frequency below 20 Hertz.

17. The method of claim 15, where the data signal contains information indicating an emergency condition, wherein the emergency condition is a tornado in a geographical region of the plurality of network equipment.

18. The method of claim 15, where the data signal further comprises data selected from the group consisting of: a location of a tornado, a direction of travel of a tornado, a speed of travel of a tornado, a frequency of the low frequency sound wave, an amplitude of the low frequency sound wave, a time of detection of the low frequency sound wave, and a combination of two or more thereof.

19. The method of claim 17, further comprising transmitting a second data signal from the second network equipment, the second data signal containing an update to the emergency condition.

20. The method of claim 15, where the first network equipment and the second network equipment are the same equipment.
